(19) United States
(12) Patent Application Publication
(10) Pub. No.: US 2026/0344925 A1
(43) Pub. Date: Nov. 5, 2026

(54) LIQUID POURING ASSIST FILTER

(71) Applicant: THREE RIVERS CO., LTD., Saga (JP)

(72) Inventor: Takashi Mikawa, Saga (JP)

(21) Appl. No.: 19/123,627

(22) PCT Filed: Oct. 19, 2023
(86) PCT No.: PCT/JP2023/037859

§ 371 Date: Apr. 23, 2025

(30) Foreign Application Priority Data
Nov. 1, 2022 (JP) 2022-175787

(51) Int. Cl. A47J 31/44

(52) U.S. Cl. CPC A47J 31/44

(57) ABSTRACT

Provided is a liquid pouring assist filter which can easily disperse and pour a liquid with a simple configuration. A liquid pouring assist filter 1 for a drink comprises: a main body part 10 which has a bottomed cylindrical shape, at least a bottom part 11 of which is porous, and which receives a poured liquid such as hot water; and a plurality of protrusions 20 which are porous and which are formed on a lower surface 112 of the bottom part 11 of the main body part 10 that is a surface located on a side opposite from a side on which the liquid is poured, wherein the main body part 10 and the protrusions 20 are made of porous ceramic.

### TECHNICAL FIELD

The present invention relates to a liquid pouring-aid filter for beverages.

### BACKGROUND ART

Conventionally, there has been known a device for pouring a liquid into powdered ground coffee beans or tea leaves when a beverage such as coffee or tea is brewed. For example, Patent Document 1 discloses a device that stores hot water poured from a water supply port in a hot water storage tank and sprays the stored hot water via a pipe, etc. from a shower onto a ground coffee bean bucket.

### CITATION LIST

### Patent Document

Patent Document 1: Japanese Unexamined Patent Application, Publication No. H6-209858

### DISCLOSURE OF THE INVENTION

### Problems to be Solved by the Invention

In the case of extracting a beverage such as coffee, for example, a coffee excellent in taste and flavor can be extracted by dispersing and pouring the liquid at a predetermined speed rather than locally pouring the liquid into a filter containing coffee beans or the like. In the device of Patent Document 1, although a liquid can be dispersed and poured into a filter containing coffee beans, there is room for improvement in terms of simplifying the configuration of the device because the liquid is poured into the filter through various parts such as a pipe, a water storage tank, and a heater.

An object of the present invention is to provide a liquid pouring-aid filter capable of easily dispersing and pouring a liquid with a simple configuration.

### Means for Solving the Problems

The present invention relates to a liquid pouring-aid filter for beverages. The liquid pouring-aid filter for beverages includes a body having a bottomed cylindrical shape, at least a bottom of the body being porous, and the body being configured to receive a liquid to be poured; and a plurality of porous protrusions formed on a lower surface of the bottom of the body, the lower surface being a surface located on a side opposite to a side from which a liquid is poured.

The body and the protrusions are made of a porous ceramic.

The body and the protrusions have a median pore diameter of 80 μm to 180 μm.

The bottom has a substantially uniform thickness and is flat.

The lower surface of the bottom is formed so as to become closer to an opening that faces the bottom and through which the liquid is poured, toward a center of the bottom.

The lower surface of the bottom is formed so as to become more distant from an opening that faces the bottom and through which the liquid is poured, toward a center of the bottom.

### Effects of the Invention

According to the present invention, a liquid can be easily dispersed and poured with a simple configuration.

### BRIEF DESCRIPTION OF THE DRAWINGS

FIG. 1 is a perspective view showing a liquid pouring-aid filter according to a first embodiment;

FIG. 2 is a side view showing the liquid pouring-aid filter according to the first embodiment;

FIG. 3 is a plan view showing the liquid pouring-aid filter according to the first embodiment;

FIG. 4 is a bottom view showing the liquid pouring-aid filter according to the first embodiment;

FIG. 5 is a cross-sectional view of the liquid pouring-aid filter shown in FIG. 4 taken along line V-V;

FIG. 6 shows a modification of protrusions of the liquid pouring-aid filter according to the first embodiment and corresponds to FIG. 4;

FIG. 7 is a schematic view showing an example of use of the liquid pouring-aid filter according to the first embodiment;

FIG. 8 shows a liquid pouring-aid filter according to a second embodiment and corresponds to FIG. 4; and

FIG. 9 shows a liquid pouring-aid filter according to a third embodiment and corresponds to FIG. 4.

### PREFERRED MODE FOR CARRYING OUT THE INVENTION

Hereinafter, embodiments of the present invention will be described. However, the present invention is not limited to the following embodiments.

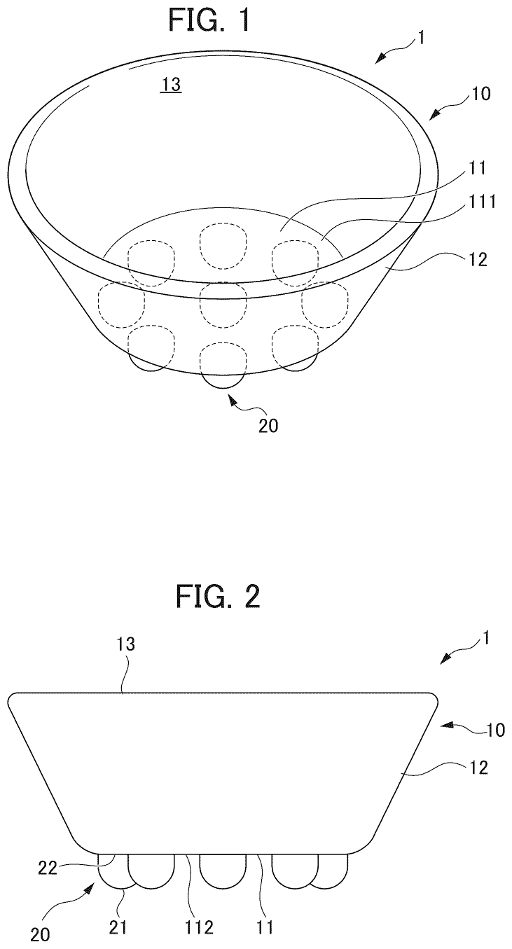

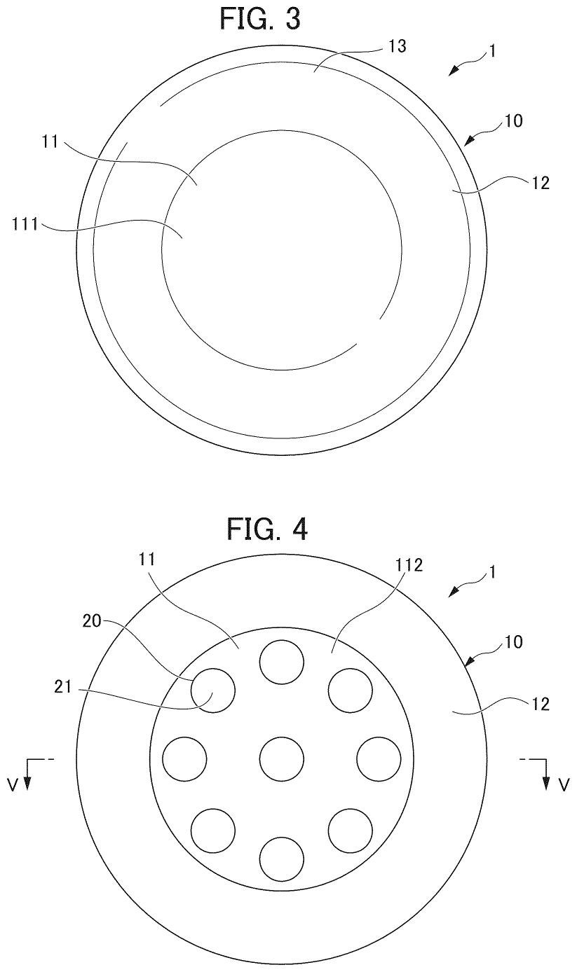

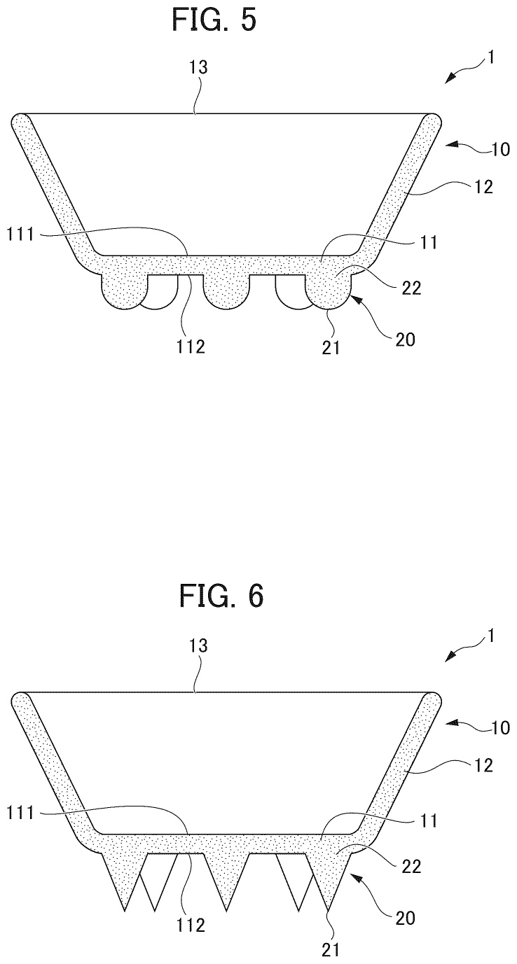

A liquid pouring-aid filter 1 according to a first embodiment will be described with reference to FIGS. 1 to 5. FIG. 1 is a perspective view of the liquid pouring-aid filter 1. FIG. 2 is a side view of the liquid pouring-aid filter 1. FIG. 3 is a plan view of the liquid pouring-aid filter 1. FIG. 4 is a bottom view of the liquid pouring-aid filter 1. FIG. 5 is a cross-sectional view of the liquid pouring-aid filter 1 shown in FIG. 4 taken along line V-V.

The liquid pouring-aid filter 1 of the present embodiment is used when a beverage is extracted from coffee beans or tea leaves and filtered, and is an instrument for aiding the pouring of liquid onto coffee beans or tea leaves. For example, the user can dispose the liquid pouring-aid filter 1 above a filter or the like containing ground coffee beans and disperse and pour liquid such as hot water into the filter or the like through the liquid pouring-aid filter 1.

The configuration of the liquid pouring-aid filter 1 will be described. The liquid pouring-aid filter 1 includes a body 10 that receives the liquid to be poured, and a plurality of protrusions 20.

The body 10 has a bottomed cylindrical shape and includes a bottom 11, a side 12, and an opening 13 that faces the bottom 11 and through which the liquid is poured. In the body 10, at least the bottom 11 is porous. The liquid pouring-aid filter 1 according to the present embodiment is formed of a porous ceramic in which a large number of micropores are formed. That is, the entire body 10 including the side 12 is made of a porous ceramic.

As shown in FIG. 3, the bottom 11 has a circular shape in plan view, but the shape thereof is not limited. For example, the bottom 11 may have an elliptical shape or a polygonal shape in plan view.

As shown in FIGS. 2 and 5, the bottom 11 has a constant thickness and is flat. That is, a surface (hereinafter, referred to as an upper surface) 111 of the bottom 11 on the side to which the liquid is poured and a surface (hereinafter, referred to as a lower surface) 112 opposite to the upper surface 111 are flat. A plurality of protrusions 20 are formed on the lower surface 112 of the bottom 11. The thickness of the bottom 11 is preferably 3 mm to 5 mm from the viewpoint of maintaining the strength of the body 10 and reliably collecting the liquid poured into the body 10 into the protrusions 20 and dripping the liquid from the protrusions 20.

The side 12 is a portion rising from the peripheral edge portion of the bottom 11. The side 12 is formed so as to become more distant from the center of the bottom 11 in plan view as the distance from the bottom 11 increases. That is, the body 10 is formed in a tapered shape whose diameter increases from the bottom 11 toward the opening 13. This facilitates the supply of liquid to the body 10 and allows the liquid to be smoothly collected from the bottom 11 to the protrusions 20. The center of the bottom 11 is a position through which the central axis of the body 10 passes in the bottom 11.

The plurality of protrusions 20 are made of a porous ceramic and are formed on the lower surface 112 so as to protrude in a direction away from the bottom 11. In the present embodiment, as shown in FIG. 4, nine protrusions 20 are formed on the lower surface 112 of the bottom 11. Specifically, one protrusion 20 is formed at the center of the lower surface 112 of the bottom 11, and eight protrusions 20 are formed at substantially equal intervals along the circumferential direction of the bottom 11 on the peripheral edge portion side thereof.

In the present embodiment, the plurality of protrusions 20 each have substantially the same size and shape. As shown in FIGS. 2 and 5, the protrusion 20 has a cylindrical shape whose axial direction extends substantially parallel to the axial direction of the body 10, and a leading end 21 opposite to the bottom 11 has a spherical shape. In the present embodiment, the body 10 and the protrusion 20 are integrally and entirely molded from a porous ceramic having a filtration function.

Here, when the liquid is poured into the body 10 with the opening 13 facing upward and the bottom 11 facing downward, the liquid poured into the body 10 is collected from the bottom 11 to each of the protrusions 20 and drops downward mainly from the leading end 21 of each of the protrusions 20. This is because since the bottom 11 and each of the protrusions 20 are porous, the liquid poured into the body 10 flows through the micropores in the bottom 11 and the protrusions 20 and is stored in the protrusions 20 located below the bottom 11, from the bottom 11. The manner in which the liquid drops can be adjusted by changing the design of the shape, size, position, or the like of the protrusions 20.

For example, in the example shown in FIG. 4, since the protrusions 20 are formed on the center and the peripheral edge portion side of the bottom 11, the liquid can be dispersed and dropped from the center and the peripheral edge portion side of the bottom 11. Additionally, since the bottom 11 is flat, the thickness thereof is uniform, and the shapes and sizes of the plurality of protrusions 20 are substantially equal to each other, the liquid can uniformly drip from each of the protrusions 20 at substantially the same speed.

At least the bottom 11 and the protrusions 20 of the body 10 preferably have a median pore diameter of 80 μm to 180 μm, and more preferably 100 μm to 130 μm. This allows the liquid poured into the body 10 to be reliably and efficiently collected from the bottom 11 to each of the protrusions 20 and drip from each of the protrusions 20.

Next, the relationship between the conditions such as the shape, the arrangement, and the size of the protrusions 20 that can be taken by the liquid pouring-aid filter 1 of the present embodiment and the drop state of the liquid from the liquid pouring-aid filter 1 will be described.

In the liquid pouring-aid filter 1, for example, the dripping speed of the liquid or the size of the droplets can be adjusted by changing the size of the protrusion 20. Specifically, by increasing the size of the protrusion 20, the frequency of liquid drips per unit time (hereinafter, referred to as drip frequency) can be suppressed, and the size of the droplets can be increased. Further, for example, by reducing the size of the protrusion 20, the dripping frequency can be increased, and the size of the droplets can be reduced. When the size of the protrusion 20 is smaller than a predetermined size, the liquid can fall in a continuous linear manner rather than in an individual droplet manner. When the pore diameter of the micropores in the bottom 11 and the protrusion 20 is increased, the dripping frequency can be increased, and on the contrary, when the pore diameter is decreased, the dripping frequency can be decreased.

Further, for example, in the liquid pouring-aid filter 1, the position where the liquid drops can be adjusted by changing the position where the protrusions 20 are formed. For example, by providing the protrusions 20 only on the center C side of the bottom 11, the liquid drops only from the center of the bottom 11. Further, for example, by providing the protrusions 20 only on the peripheral edge portion side of the bottom 11, the liquid drops only from the peripheral edge portion side of the bottom 11.

Further, for example, in the liquid pouring-aid filter 1, the manner in which the liquid drops differs depending on the shape of the protrusion 20. FIG. 6 is a cross-sectional view showing a modification of the protrusions 20 of the liquid pouring-aid filter 1. For example, the shape of the protrusion 20 may be an inverted polygonal pyramid or a cone that tapers away from the lower surface 112. This allows the liquid poured into the body 10 to be efficiently collected from the bottom 11 to each of the protrusions 20, while allowing the liquid to drop from each of the protrusions 20 as smaller droplets or to fall in a continuous linear manner.

Further, for example, the protrusion 20 may have a shape in which the width increases as the distance from the lower surface 112 increases. This allows the size of the droplets dropping from the protrusion 20 to be increased, and also allows the contact area between the base end 22 of the protrusion 20 on the lower surface 112 side and the lower surface 112 to be reduced, thereby reducing the speed at which the liquid flows from the bottom 11 to the protrusion 20 and further suppressing the dripping frequency of the droplets. Further, for example, by forming the leading end 21 of the protrusion 20 in a spherical shape as in the present embodiment, it is possible to increase the dripping frequency of the droplets even when the protrusion 20 is made large.

As described above, various dropping conditions such as the dripping frequency of the liquid, the size of the droplets, and the dropping position can be realized by a simple design change in the shape, size, position, or the like of the protrusions 20. Therefore, for example, by a simple design change, it is possible to manufacture the liquid pouring-aid filter 1 that reproduces the pouring method for each barista.

Further, by adjusting the thickness of the bottom 11 and the size of the micropores of the bottom 11 and the protrusions 20, the temperature of the liquid dropping from the liquid pouring-aid filter 1 can be adjusted. For example, by setting the thickness of the bottom 11 to 3 mm to 5 mm and the median pore diameter of the bottom 11 and the protrusions 20 to 100 μm to 130 μm, when hot water of 100 °C is poured into the body 10, hot water of 90 °C suitable for extraction of coffee can be dropped.

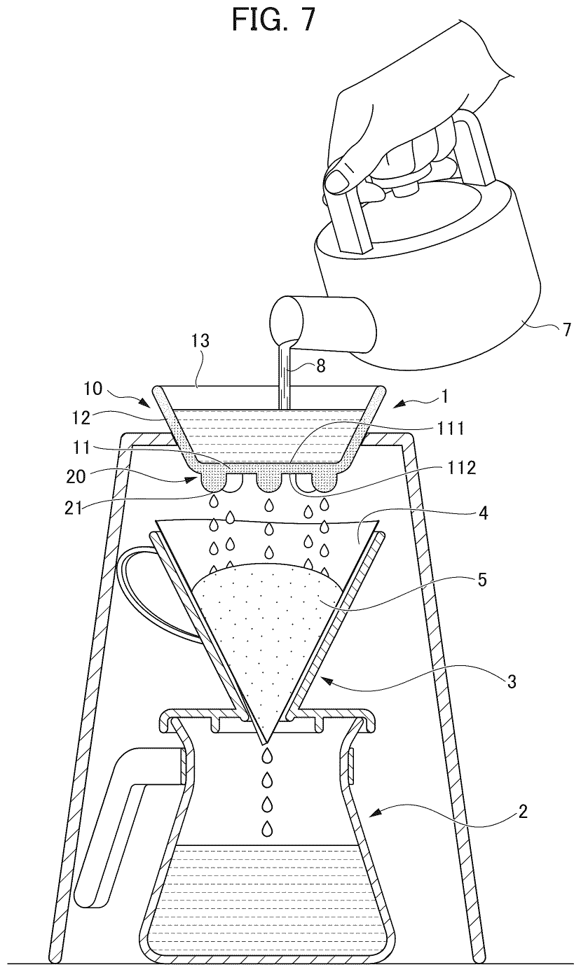

Next, an example of use of the liquid pouring-aid filter 1 will be described with reference to FIG. 7. FIG. 7 is a schematic view showing an example of use of the liquid pouring-aid filter 1 in the case of extracting coffee.

In the case of extracting coffee using the liquid pouring-aid filter 1, as shown in FIG. 7, first, a server 2 for collecting the extracted coffee, a dripper 3, and a filter 4 containing powdered coffee beans 5 are prepared. The filter 4 containing the powdered coffee beans 5 is attached to the dripper 3 and disposed on the top of the server 2. Then, the liquid pouring-aid filter 1 is disposed above the filter 4 in a state of being supported by a support member 6. At this time, the liquid pouring-aid filter 1 is disposed so that the leading end 21 of the protrusion 20 faces the filter 4 side.

Next, as shown in FIG. 7, hot water 8 is poured from a kettle 7 by the user through the opening 13 of the liquid pouring-aid filter 1. As a result, the hot water 8 flows from the upper surface 111 of the bottom 11 through the micropores in the bottom 11, is stored in each protrusion 20 in which the micropores are formed, and flows toward the filter 4 as droplets. At this time, a plurality of droplets drop onto the coffee beans 5 in the filter 4 at a constant speed from the protrusions 20 disposed on the entire bottom 11. Then, the coffee extract extracted by the dropped hot water 8 flows from the dripper 3 to the server 2. As a result, as shown in FIG. 7, even when coffee is extracted by using the kettle 7 or the like having a wide pouring port, the hot water 8 poured from the kettle 7 through the liquid pouring-aid filter 1 can be dispersed at a constant speed and dropped into the filter 4. This allows the coffee beans 5 to be extracted while slowly steaming the whole of the coffee beans 5, and coffee with superior taste and flavor can be extracted compared to the case where hot water 8 is poured locally using only the kettle 7.

Next, an example of a method of manufacturing the liquid pouring-aid filter 1 of the present embodiment will be described. The method of manufacturing the liquid pouring-aid filter 1 of the present embodiment includes, for example, a kneading step, a molding step, a drying step, and a firing step.

In the kneading step, kneading is performed so that the material of the liquid pouring-aid filter 1 becomes clay. In the kneading step, alumina, bentonite, water-insoluble organic fine particles, and water are mixed together to obtain a kneaded mixture. All of the alumina, bentonite and water-insoluble organic fine particles are in the form of powder. As the water-insoluble organic fine particles, for example, powdery crystalline cellulose can be used.

In the molding step, the kneaded mixture obtained in the kneading step is placed into a filter mold made of plaster, and the filter mold is pressed with a predetermined force. The filter mold is composed of an inner mold that forms the inner side of the body 10 of the liquid pouring-aid filter 1, and an outer mold that forms the outer side of the body 10 and the protrusions 20. In the molding step, pressing is carried out for about one hour. This results in a molded product.

In the drying step, the molded product molded in the molding step is removed from the filter mold and dried. The drying time in the drying step can be set as appropriate depending on air temperature, humidity, or the like. The drying in the drying step is performed, for example, for about 3 days in an environment of 25 °C and 60% humidity.

In the firing step, the molded product molded in the molding step and dried in the drying step is fired. More specifically, the molded product dried in the drying step is first subjected to burr finishing. In the burr finishing, burrs, which are unnecessary portions of the product, are scraped off from the molded product. Thereafter, the molded product that has been subjected to the burr finishing is fired at 1200 °C to 1300 °C for 10 hours to 15 hours. In this firing step, the water-insoluble organic fine particles contained in the molded product are decomposed to form a large number of micropores. Micropores are also formed by evaporation of moisture remaining in the molded product. Through the above steps, the liquid pouring-aid filter 1 is manufactured.

According to the liquid pouring-aid filter 1 of the first embodiment, the following effects are achieved.
(1) A liquid pouring-aid filter 1 includes a body 10 having a bottomed cylindrical shape, at least a bottom 11 of the body 10 being porous, and the body 10 being configured to receive a liquid to be poured; and a plurality of porous protrusions 20 formed on a lower surface 112 of the bottom 11 of the body 10, the lower surface 112 being a surface located on a side opposite to a side from which a liquid is poured. Accordingly, since the body 10 and the protrusions 20 are porous, the liquid poured into the body 10 can be collected into the plurality of protrusions 20 from the micropores in the bottom 11 and the protrusions 20, and the liquid can be dropped not locally but dispersed and dropped from the plurality of protrusions. Therefore, the liquid can be easily dispersed and poured with a simple configuration. Therefore, for example, in the case of extracting coffee, only by pouring hot water into the body 10, the hot water can be dispersed and poured into the filter containing coffee beans, and coffee excellent in taste and flavor can be easily extracted without using a dedicated device or the like. Further, by changing the design of the position, size, shape, or the like of the protrusions 20, various liquid dropping conditions can be created, making it possible, for example, to reproduce the way various baristas pour liquids.
(2) In the liquid pouring-aid filter 1, the body 10 and the protrusions 20 are made of a porous ceramic. This allows the liquid to drip through the micropores of the ceramic, making the liquid taste mild. For example, when it is used for coffee extraction, coffee having more excellent taste and flavor can be extracted.
(3) In the liquid pouring-aid filter 1, the body 10 and the protrusions 20 have a median pore diameter of 80 μm to 180 μm. As a result, it is possible to more reliably and smoothly collect the liquid from the bottom 11 to each of the protrusions 20 and drop the liquid from each of the protrusions 20.
(4) In the liquid pouring-aid filter 1, the bottom 11 has a substantially uniform thickness and is flat. Thus, the liquid can be uniformly poured from the plurality of protrusions 20 by making the sizes and shapes of the plurality of protrusions 20 the same.

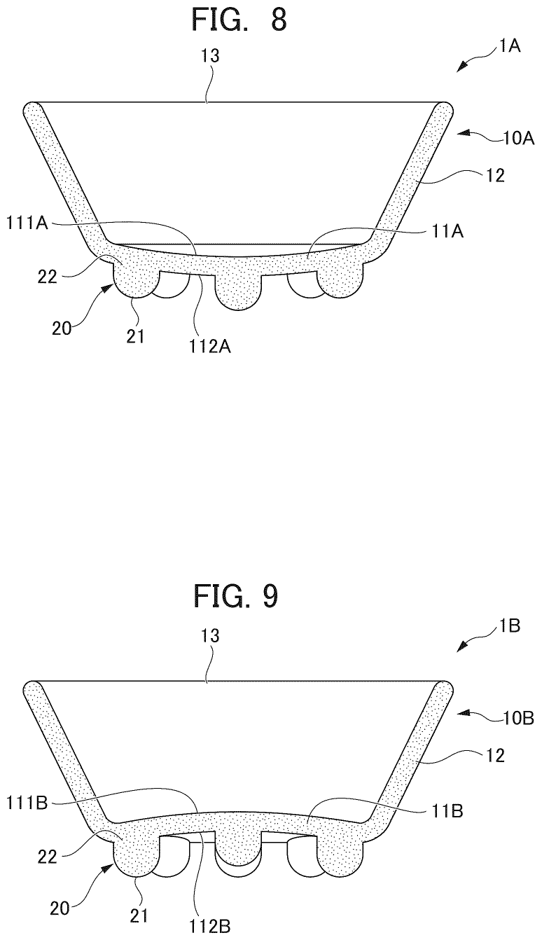

Next, a body 10 of a liquid pouring-aid filter 1A according to a second embodiment will be described with reference to FIG. 8. FIG. 8 shows the liquid pouring-aid filter 1A according to the second embodiment and corresponds to FIG. 4. Note that the same components as those of the above embodiment are denoted by the same reference numerals, and descriptions thereof may be omitted.

Next, the liquid pouring-aid filter 1A according to the second embodiment differs from that of the first embodiment mainly in the feature of a bottom 11A of a body 10A.

The body 10A of the liquid pouring-aid filter 1A has a bottomed cylindrical shape and includes a bottom 11A, a side 12, and an opening 13. A plurality of protrusions 20 are formed on a lower surface 112A of the bottom 11A.

As shown in FIG. 8, the bottom 11A is formed in an arc shape that bulges in a direction opposite to the opening 13 in longitudinal sectional view. Specifically, the bottom 11A is formed so as to become more distant from the opening 13 toward the center of the bottom 11A. The thickness of the bottom 11A is constant. That is, an upper surface 111A and a lower surface 112A of the bottom 11A are also formed to become more distant from the opening 13 toward the center of the bottom 11A.

According to the liquid pouring-aid filter 1A of the second embodiment, in addition to the above (1) to (3), the following effects are achieved.
(5) In the liquid pouring-aid filter 1A, the lower surface 112A of the bottom 11A is formed so as to become more distant from the opening 13 that faces the bottom 11A and through which the liquid is poured, toward a center of the bottom 11A. Accordingly, since the protrusion 20 formed on the center side is located lower than the peripheral edge portion of the bottom 11A, when a plurality of protrusions 20 having substantially the same shape and size are formed on the bottom 11A, more liquid can drip from the protrusion 20 formed on the center side of the bottom 11A than on the peripheral edge portion side.

Next, a body 10B of a liquid pouring-aid filter 1B according to a third embodiment will be described with reference to FIG. 9. FIG. 9 shows the liquid pouring-aid filter 1B according to the third embodiment and corresponds to FIG. 4. Note that the same components as those of the first embodiment are denoted by the same reference numerals, and the descriptions thereof may be omitted.

The liquid pouring-aid filter 1B according to the third embodiment differs from that of the first embodiment mainly in the feature of a bottom 11B of the body 10B.

The body 10B of the liquid pouring-aid filter 1B has a bottomed cylindrical shape and includes the bottom 11B, a side 12, and an opening 13. A plurality of protrusions 20 are formed on a lower surface 112B of the bottom 11B.

As shown in FIG. 9, the bottom 11B is formed in an arc shape that bulges toward the opening 13 in longitudinal sectional view. Specifically, the bottom 11B is formed so as to become closer to the opening 13 toward the center of the bottom 11B. Further, the thickness of the bottom 11B is constant. That is, an upper surface 111B and the lower surface 112B of the bottom 11B are also formed so as to become closer to the opening 13 toward the center of the bottom 11B.

According to the liquid pouring-aid filter 1B of the third embodiment, in addition to the above (1) to (3), the following effects are achieved.
(6) In the liquid pouring-aid filter 1B, the lower surface 112B of the bottom 11B is formed so as to become closer to the opening 13 that faces the bottom 11 and through which the liquid is poured, toward a center of the bottom 11B. Accordingly, since the protrusions 20 formed on the peripheral edge portion side are located lower than on the center of the bottom 11B, when a plurality of protrusions 20 having substantially the same shape and size are formed on the bottom 11B, more liquid can be dropped from the protrusion 20 formed on the peripheral edge portion side than on the center side of the bottom 11B.

Although the embodiments of the present invention have been described above, the present invention is not limited to the above-described embodiments and can be modified as appropriate.

In the liquid pouring-aid filter 1 shown in FIGS. 1 to 4, the sizes of the plurality of protrusions 20 are formed to be substantially equal to each other, but the sizes of the protrusions 20 may be changed depending on the positions where the protrusions 20 are formed. For example, the liquid pouring-aid filter 1 may be configured such that the size of the protrusion 20 at the center of the bottom 11 is larger than that on the peripheral edge portion side. This allows a larger proportion of the liquid to drop from the protrusion 20 on the center side of the bottom 11 than that on the peripheral edge portion side. In addition, for example, the liquid pouring-aid filter 1 may be configured such that the size of the protrusion 20 on the peripheral edge portion side of the bottom 11 is larger than that at the center. This allows a larger proportion of the liquid to drop from the protrusion 20 on the peripheral edge portion side of the bottom 11 than that on the center side.

In the above-described embodiments, the body 10 and the protrusions 20 are integrally molded, but the body 10 and the protrusions 20 may be joined after being separately manufactured.

### EXPLANATION OF REFERENCE NUMERALS

11 liquid pouring-aid filter
10 body
11 bottom
20 protrusion

1. A liquid pouring-aid filter for beverages, comprising:
a body having a bottomed cylindrical shape, at least a bottom of the body being porous, and the body being configured to receive a liquid to be poured; and
a plurality of porous protrusions formed on a lower surface of the bottom of the body, the lower surface being a surface located on a side opposite to a side from which a liquid is poured,
wherein the body and the protrusions are entirely made of a porous ceramic having a filtration function.

2. The liquid pouring-aid filter according to claim 1, wherein the body and the protrusions have a median pore diameter of 80 μm to 180 μm.

3. The liquid pouring-aid filter according to claim 1, wherein the bottom has a substantially uniform thickness and is flat.

4. The liquid pouring-aid filter according to claim 1, wherein the lower surface of the bottom is formed so as to become closer to an opening that faces the bottom and through which the liquid is poured, toward a center of the bottom.

5. The liquid pouring-aid filter according to claim 1, wherein the lower surface of the bottom is formed so as to become more distant from an opening that faces the bottom and through which the liquid is poured, toward a center of the bottom.
